(19) United States
(12) Patent Application Publication
(10) Pub. No.: US 2008/0235244 A1
(43) Pub. Date: Sep. 25, 2008

(54) Distributed content storing system, node device, node process program, and content data providing method

(75) Inventor: Hideki Matsuo, Nagoya-shi (JP)

Correspondence Address: OLIFF & BERRIDGE, PLC, P.O. BOX 320850, ALEXANDRIA, VA, 22320-4850, US

(73) Assignee: BROTHER KOGYO KABUSHIKI KAISHA, NAGOYA-SHI (JP)

(21) Appl. No.: 12/073,345

(22) Filed: Mar. 4, 2008

(30) Foreign Application Priority Data
Mar. 23, 2007 (JP) 2007-076015

(51) Int. Cl. G06F 17/30; G06F 7/00

(52) U.S. Cl. 707/10; 707/E17.032

(57) ABSTRACT

A node device included in a distributed content storing system which includes a plurality of node devices mutually communicable through a network, the node device including:
a means for receiving storing request information indicative of storing request of the content data;
a means for judging whether or not a standard for determining a degree of load of the network in response to the storing request information; and
a means for acquiring and storing content data related to the storing request information from another node device storing the content data through the network in a case where the standard is satisfied.

The entire disclosures of Japanese Patent Application No. 2007-076015 filed on Mar. 23, 2007 including the specification, claims, drawings and summary are incorporated herein by reference in its entirety.

### BACKGROUND OF THE INVENTION

1. Field of the Invention

The present invention relates to a peer to peer (P2P) type communication system including a plurality of node devices mutually communicable through a network.

2. Discussion of Related Art

As this kind of peer to peer type communication system, a distributed content storing system in which a replica (copied data) of content data is distributed and located (distribution storing) into a plurality of node devices is known. By using this system, fault tolerance and property of distributing accesses is enhanced. Location of the replica of content data thus distributed and stored can be efficiently searched for by use of a distributed hash table (hereinafter referred to as “DHT”) as shown in Japanese Unexamined Patent Publication No. 2006-197400. The DHT is stored by each node device and in the DHT, node information indicating a plurality of node devices to be transfer destinations of various types of messages (for example, including IP addresses and port numbers) are registered.

Then, in a case where a node devices participating in a content distribution storing system requests acquisition of desired content data, a message (query) for searching for (finding) location of a replica of the content data is transmitted to another node device. The message is transferred by a relay node device to a node device which manages location of the replica of the content data in accordance with the DHT and finally information indicating the location is acquired from the node device which manages the location of the replica of the content data. Thus, the node device which has transmitted the message requests the replica of the content data thus searched to a node device storing the replica of the content data and can receive the replica of the content data.

### SUMMARY OF THE INVENTION

Meanwhile, there is a case where many node devices are connected to one line included in a network of such a distributed content storing system through a relay device such as a router. Therefore, for example depending on time, many node devices share one line. In such a case, load of the network and the relay device such as a router is increased, and therefore it is not preferable.

The present invention has been made in consideration of the above problem, and the object of the present invention is to provide a distributed content storing system, a node device, a node process program, and a content data providing method which enables to reduce load in a network and a relay device such as a router even in a case where many node devices are connected to one line included in the network.

In order to solve the above problems, according to the invention recited in Claim 1, there is provided a node device included in a distributed content storing system which includes a plurality of node devices enabled to mutually communicated through a network, the plurality of node devices including a plurality of content data distributed and stored therein, the node device including:

a storing request receiving means for receiving storing request information indicative of storing request of the content data;

a standard judgment means for judging whether or not a standard for determining a degree of load of the network in response to the storing request information; and

a content data acquisition means for acquiring and storing content data related to the storing request information from another node device storing the content data through the network in a case where the standard is satisfied.

According to the invention, in a case where the node device receives storing request information indicative of storing request of the content data, it is judged whether or not a standard of determining a degree of load in the network is satisfied. In a case where the standard is satisfied, it is constructed to acquire and store the content data from another node device, storing the content data related to the storing request information, through the network. Therefore, even in a case where many node devices are connected through a relay device such as a router to one line constructing the network, it is possible to reduce load on the network and the relay device.

According to the present invention, a node device judges whether or not a standard for determining a degree of load of the network is satisfied. In a case where the standard is satisfied, content data are acquired or transmitted to the other node device through the network. Therefore, even in a case where many node devices are connected to one line included in the network through a relay device such as a router, it is possible to reduce the load of the network and the relay device.

### BRIEF DESCRIPTION OF THE DRAWINGS

FIG. 1 is a view showing an example of connection status of each node device in a distributed content storing system related to the present embodiment.

FIG. 2 is a view showing an example of a routing table using DHT retained by a node N2.

FIG. 3 is a conceptual view showing an example of an ID space of DHT.

FIG. 4 is a conceptual view showing an example of flow of a content location inquiry (search) message, transmitted from a user node in an ID space of DHT.

FIG. 5 is a view showing a schematic configuration example of a node Nn.

FIG. 6 is a flowchart showing main process in a control unit 11 of the node Nn.

FIG. 7 is a flowchart showing details of system usage restriction judgment process in FIGS. 6 and 10.

FIG. 8 is a flowchart showing details of content data acquisition process in FIGS. 6 and 10.

FIG. 9 is a flowchart showing details when system usage is restricted in FIGS. 6 and 10.

FIG. 10 is a flowchart showing details of message receiving process in FIG. 6.

FIG. 11 is a view showing how each block of replica of content data is transmitted by a content retention node interposing a transmission interval T1.

### DETAILED DESCRIPTION OF THE PREFERRED EMBODIMENTS

Hereinafter, each designation of numerical reference in the drawings is typically as follows:
8: Network;
9: Overlay network;
11: Control unit;
12: Memory unit;
13: Buffer memory;
14: Decoder;
15: Image processing unit;
16: Display unit;
17: Audio processing unit;
18: Speaker;
20: Communication unit;
21: Input unit;
22: Bus;
Nn: Node; and
S: Distributed content storing system

Hereinafter, an embodiment of the present invention will be described in reference of figures. Here, the embodiment explained below is an embodiment in a case where the present invention is applied to a distributed content storing system.

### [1. Configuration and the Like of a Distributed Content Storing System]

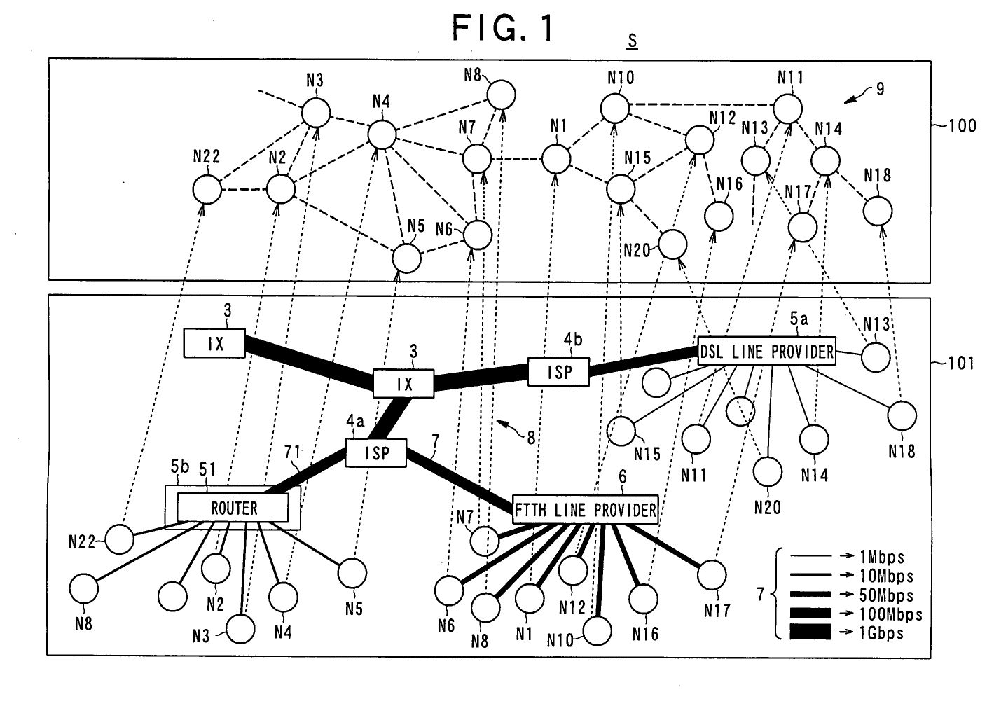

First of all, with reference to FIG. 1, schematic configuration and the like of a distributed content storing system according to the present embodiment will be explained.

FIG. 1 is a diagram showing an example of connection status of each node device in a distributed content storing system according to the present embodiment.

As shown in lower rectangular frame 101 in FIG. 1, a network 8 (communication network in real world and an example of a communication means) of the Internet or the like is constructed by an internet exchange (IX) 3, internet service providers (ISP) 4a and 4b, digital subscriber line providers (or device thereof) (DSL) 5a and 5b, fiber to home line provider ('s device) 6, and communication line (for example, such as a telephone line or an optical cable) 7 and the like. Here, in the network (a communication network) 8 of the example of FIG. 1, a router for transferring data (packet) is appropriately inserted.

In such a network 8, a plurality of node devices (hereinafter referred to as a “node”) Nn (n=any one of 1, 2, 3, . . . ) are connected. Moreover, as shown in the DSL line provider 5a of FIG. 1, a plurality of nodes N2 to N5, N8, and the like are connected through a router 51 (the nodes share one same line 71) to a line (communication line) 71 included in the network 8. Here, a mark (circle) without a numeral Nn which is connected to the router 51 indicates a general terminal (for example, a PC) which is not related to the distributed content storing system S.

A unique manufacturing number and an internet protocol (IP) address are assigned to each of the nodes Nn. Such manufacturing numbers and IP addresses do not overlap among a plurality of nodes Nn.

Then, the distributed content storing system S according to the present embodiment is a peer to peer type network system formed by participation of any plurality of nodes Nn of these nodes Nn, as shown in upper rectangular 100 of FIG. 1. Here, a network 9 shown in the upper rectangular 100 of FIG. 1 is an overlay network 9 (a logical network) including a virtual link formed by use of an existing network 8. Such an overlay network 9 is realized by a specific algorithm, for example, an algorithm using a distributed hash table (DHT).

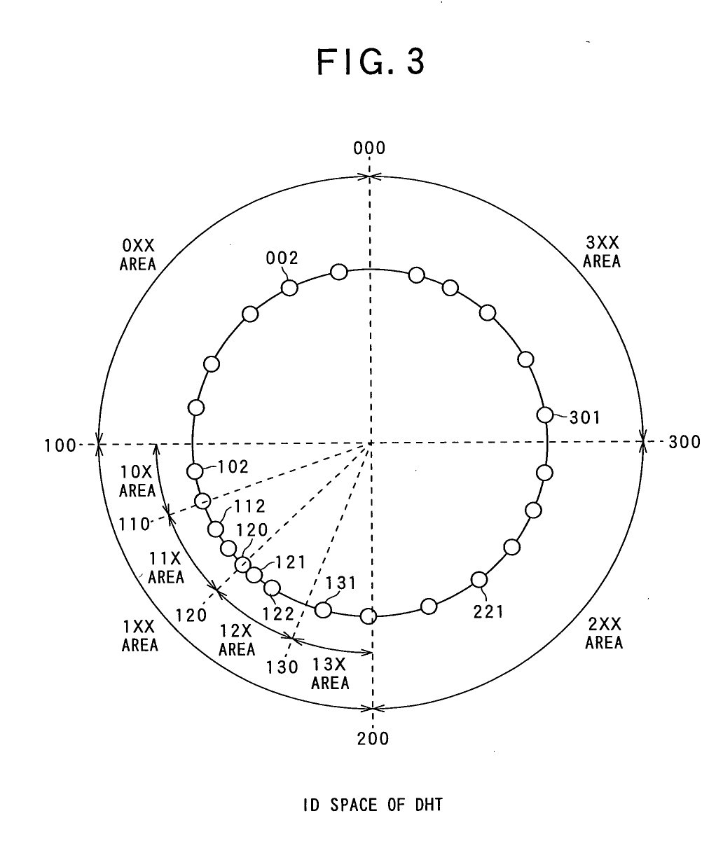

Then, each of the nodes Nn participating in the distributed content storing system S (in other words, the overlay network 9) has a node ID allocated as inherent identification information as many as a predetermined number of digit. For example, the node ID is a hashed value obtained by hashing an IP address or manufacturing number (e.g. bit length is 160 bit), individually allocated to each of the nodes, by a common hash function (e.g. SHA-1), whereby the nodes are distributed and located in one ID space without deviation, as shown in FIG. 3.

Participation into the distributed content storing system S is done when a node Nn which not participating in it (for example, a node N8) transmits a participation message indicative of a participation request to an arbitrary node Nn already participating in the system (e.g. a contact node always participating in the system S).

As described above, the node ID obtained by a common hash function (hashed) has a very low possibility of having the same value if the IP address or the manufacturing number differs. It is required for the node ID to have a bit number enough to include maximum operation number of nodes. For example, when the number is a 128-bit number, the node can operate 2̂128=340×10̂36 nodes.

Moreover, each of nodes Nn retains a routing table using DHT. The routing table regulates transfer destination of various types of messages on the distributed content storing system S. Specifically, in the DHT, a plurality of node information including a node ID and IP address, port number, or the like of other nodes Nn which are appropriately apart in the ID space are registered.

One node Nn participating in the distributed content storing system S registers node information of minimum and necessary nodes Nn of all the nodes Nn participating in the system S in the routing table. With respect to a node Nn with its node information not known (not registered), various types of messages are transferred between each nodes Nn and delivered.

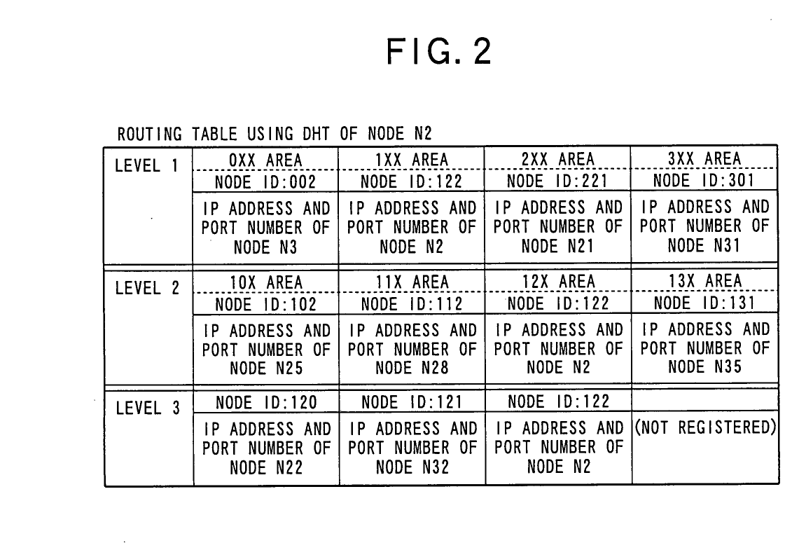

Here, with reference to FIGS. 2 and 3, a routing table using DHT will be explained.

FIG. 2 is a view showing an example of a routing table of the DHT retained by the node N. FIG. 3 is a conceptual diagram showing an example of a node ID space of the DHT.

Here, in the examples of FIGS. 2 and 3, for easy of explanation, bit length of a node ID is set up to be 2 bit×3 digits=6 bit, and each of the digits is expressed by quaternary number (an integer between 0 and 3) (practically, a longer bit length is used and each digit is divided into, for example, 4 bit each and expressed by hexadecimal of 0 to f).

In the example of FIG. 2, the routing table of the DHT includes tables of levels 1 to 3 (classified into a plurality of levels). In a table entry of each level, node IDs and IP addresses and port numbers of a node Nn corresponding to the node IDs are associated and registered as node information. Each area of a table in each level is an area obtained by dividing a node ID space of the DHT. For example, as shown in FIG. 3, in level 1, an entire ID space of the DHT is divided into four parts and an area where node IDs “000” to “033” exist is designated as a 0XX area, an area where node IDs “100” to “133” exist is designated as a 1XX area, an area where node IDs “200” to “233” exist is designated as a 2XX area, and an area where node IDs “300” to “333” exist is designated as a 3XX area. Moreover, in level 2, areas in level 1 (that is, areas “0XX” to “3XX”) are further divided into four parts. For example, a 1XX area is divided into four parts and an area where node IDs “100” to “103” exist is designated as a 10X area, an area where node IDs “110” to “113” exist is designated as a 11X area, an area where node IDs “120” to “123” exist is designated as a 12X area, and an area where node IDs “130” to “133” exist is designated as a 13X area.

Then, for example, provided that a node ID of a node N2 is “122”, as shown in FIG. 2, in a table entry of the node N2 in 1XX area (where the own node N2 exists) of level 1, a node ID, an IP address and the like of the own node N2 (because IP address belongs to the own node, registration of the IP address in the routing table is not required) are registered and in areas where the own node N2 does not exist (in other words, 0XX, 2XX, and 3XX areas), node IDs, IP addresses and the like of other arbitrary nodes Nn are registered.

Moreover, in the table of the node N2 in 12X area (an area where the own node N2 exists) in level 2, as shown in FIG. 2, node ID and IP address of the own node N2 (because IP address belongs to the own node N2, registration of the IP address in the routing table is not required) are registered and in areas where the own node does not exist (in other words, 10X, 11X, and 13X areas), node IDs and IP addresses of other arbitrary nodes Nn are registered.

Further, in level 3 of the node N2, node IDs which are between “120” and “122”, IP addresses, and the like (because IP address belongs to the own node N2, registration of the IP address in the routing table is not required) are registered, as shown in FIG. 2.

In the examples of FIGS. 2 and 3, since bit length of a node ID is set up to be three digits×2 bit, a table having three levels can cover everything. However, when bit length of a node ID is increased, more table is required for the increased amount (for example, in a case where bit length of a node ID is set to be 16 digits×4 bit, a table for 16 levels is required).

As described above, in a routing table of DHT in the present embodiment, the higher the level becomes, the narrower the area becomes.

Such DHT is given when a non-participant node participates in the distributed content storing system S.

Meanwhile, copied data (hereinafter referred to as a “replica”) of each of various content data (for example, movie, music, or the like) are distributed and saved (stored) in a plurality of nodes Nn in the distributed content storing system S.

For example, a replica of content data of a movie having a title of XXX is stored in nodes N1 and N5. Meanwhile, a replica of content data of a movie having a title of YYY is stored in a node N3. In such a manner, replicas of content data are distributed in a plurality of nodes Nn (hereinafter referred to as a “content retention node”) to be stored.

Moreover, to each of these replicas of content data, information such as a content name (title) and a content ID (identification information unique to each content) are added. The content ID is generated by, for example, hashing content name+arbitrary numerical value (or upper some bytes of the content data) by the hash function commonly used to obtain the node ID (allocated in the same ID space as the node ID). Alternatively, a system operator may give a unique ID value (same bit length as a node ID) to each content. In this case, content catalog information describing association between a content name and a content ID is distributed to all the nodes Nn.

Further, location of a replica of content data thus distributed and stored, that is, index information including a pair of an IP address or the like of a node Nn storing the replica of the content data and a content ID corresponding to the content data is stored (saved in index cache) and managed by a node Nn which manages location of the replica of the content data (hereinafter referred to as a “root node” or a “root node of the content (content ID)”).

For example, index information regarding a replica of content data of a movie having a title of XXX is managed by a node N4, being a root node of the content (content ID) and index information regarding a replica of content data of a movie having a title of YYY, is managed by a node N6 being a root node of the content (content ID) (i.e. location of a replica is managed for each content data).

In other words, because root nodes are divided with respect to each content, load is distributed. Moreover, even in a case where replicas of one same (same content) content data (same content ID) are stored in a plurality of content retention nodes, index information of such content data can be managed by one root node. Therefore, each root node recognizes a number of replicas of content data and location of the replicas is managed by the own root node in the distributed content storing system S (in other words, number of content retention nodes storing the replica).

Moreover, such a root node is set to be a node Nn having anode ID closest to, for example, a content ID (e.g. upper digits match the most).

Then, in a case where a user of a node Nn wants to acquire desired content data, the node Nn wanting to acquire the content data (hereinafter referred to as an “user node”) generates a content location inquiry (search) message (query) including a content ID of content data selected by the user (e.g. selected from content catalog information delivered to all the nodes Nn (wherein a content name, a content ID and the like are described and managed by, for example, a content catalog management server (not shown)) (for example a content name is selected) and transmits the message to another node Nn according to a routing table using DHT of the own node. That is, the user node transmits a content location inquiry (search) message to a root node (destination of the message is the root node). Thus, the content location inquiry (search) message finally reaches the root node by DHT routing using a content ID as a key.

Here, the user node also transmits a content location inquiry (search) message (query) to a root node in a case where a content input request (storing request) message (including a content name and a content ID of specific new content data) is received from, for example, a content management server of a system operator or the like as well as a case where a content name or the like is selected from the content catalog information by the user. The content input request (storing request) message (also referred to as a preliminary push message) is delivered to a plurality of arbitrary nodes Nn so that a predetermined number of replicas of new content data (content data before being publicized by content catalog information) are ensured (saved) in the distributed content storing system S. Then, when a predetermined number or more of replicas are stored in the distributed content storing system S, content catalog information in which the content name and the content ID of the new content data are described is delivered to each node Nn (the new content data is publicized by this). Alternatively, content catalog information in which attribute information of new content data to be newly inputted may be delivered to all the nodes Nn in advance. In this case, a release date of the new content data is set in the content catalog information and the content catalog information will not be publicized to (used by) a user of each node Nn until the release date. After the release date, the new content data can be requested by all the nodes Nn other than each node Nn which stored the new content data in advance in response to the input request.

Moreover, a content ID included in the content location inquiry (search) message may be generated by hashing a content name with the common hash function using the user node.

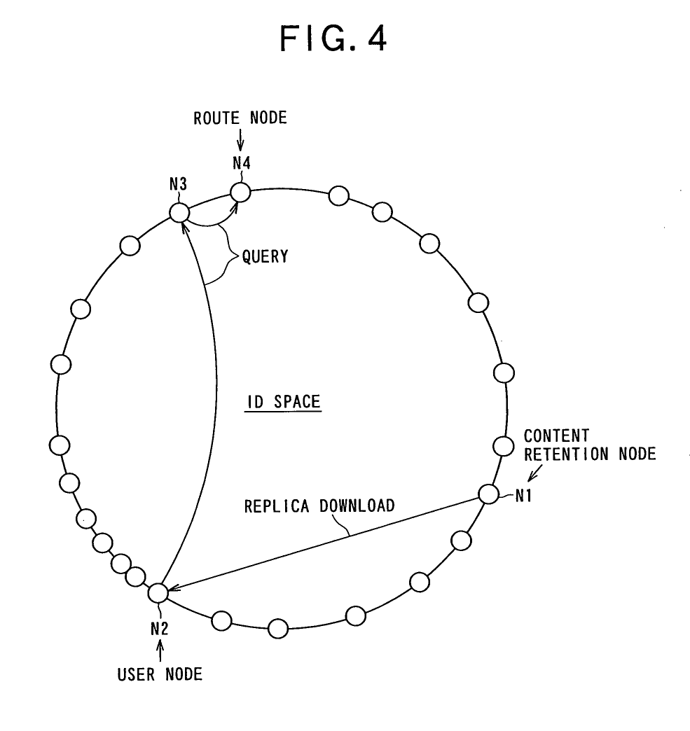

FIG. 4 is a conceptual view showing a flow of content location inquiry (search) message transmitted from a user node in an ID space of DHT.

In the example of FIG. 4, for example, a node N2 being a user node refers to a table of level 1 of the own DHT, acquires an IP address and a port number of, for example, a node N3 having a node ID closest to a content ID included in the content location inquiry (search) message (e.g. upper digits match the most), and transmits the content location inquiry (search) message (query) to the IP address and the port number.

Meanwhile, the node N3 receives the content location inquiry (search) message, refers to a table of level 2 of the own DHT, acquires an IPaddress and a port number of, for example, a node N4 having a node ID closest to a content ID included in the content location inquiry (search) message (e.g. upper digits match the most), and transfers the content location inquiry (search) message to the IP address and the port number.

On the contrary thereto, the node N4 receives the content location inquiry (search) message, refers to a table of level 3 of the own DHT, and recognizes that a node having a node ID closest (e.g. upper digits match the most) to the content ID included in the content location inquiry (search) message is the node N4 itself. In other words, the node N4 recognizes that a root node of the content ID is the node N4 itself. Then, the node N4 acquires index information corresponding to the content ID included in the content location inquiry (search) message from an index cache and replies the index information to the user node which transmitted the content location inquiry (search) message. Thus, the user node can transmit a content transmission request message to the content retention node, for example a node N1, storing a replica of desired content data and receive a replica of the content data.

Alternatively, the node N4 being a root node transmits a content transmission request message (request information including an IP address or the like of a user node indicating transmission request of a replica of content data to the user node) to a content retention node indicated by the IP address or the like included in the index information. Thus, the user node can receive a replica of the content data from, for example, the node N1 being the content retention node.

Regarding content data having a small number of replicas distributed and stored in the distributed content storing system S (number of content retention nodes storing the replica is small), even in a case where a user node transmits the above-mentioned content location inquiry (search) message (query) to the root node, there may be a case where a reply (transmission of index information) from the root node cannot be acquired quickly due to increased load of a node Nn or the network 8 (for example, a long time is required until receiving a reply or no reply is received) or a case where content data cannot be quickly provided from a content retention node storing a replica of the content data (e.g. much time is required for downloading). In such a case, though each node Nn can access a content management server storing and managing all the content data and acquire the replica, it is preferable to transmit and receive a replica of content data between nodes Nn without applying load to the content management server as much as possible.

Here, the user node may acquire (receive) the index information from a relay node (e.g. cache node of a node N3) which caches the index information same as one of a root node before the content location inquiry message reaches the root node.

The user node which acquired and stored the replica of content data in such a manner generates a publish (registration notification) message including a content ID of the content data and own IP address or the like (since the replica of content data is stored, a registration message indicating a request for registration of the IP address or the like) and transmits the publish message to a root node to thereby notify the root node that the replica is stored (i.e. to publicize that the user node retains the replica of the content data to other nodes Nn participating in the system S). Thus, the publish message reaches the root node by DHT routing using a content ID as a key in a similar manner as a content location inquiry (search) message. The root node registers index information including a pair of the IP address or the like and the content ID included in the received publish message (stores in index cache area) Thus, the user node newly becomes a content retention node retaining a replica of the content data.

Here, the index information including a pair of IP address or the like and content ID included in the publish message is registered (cached) in a relay node on a transfer route to the root node.

### [2. Configuration, Function and the Like of Node Nn]

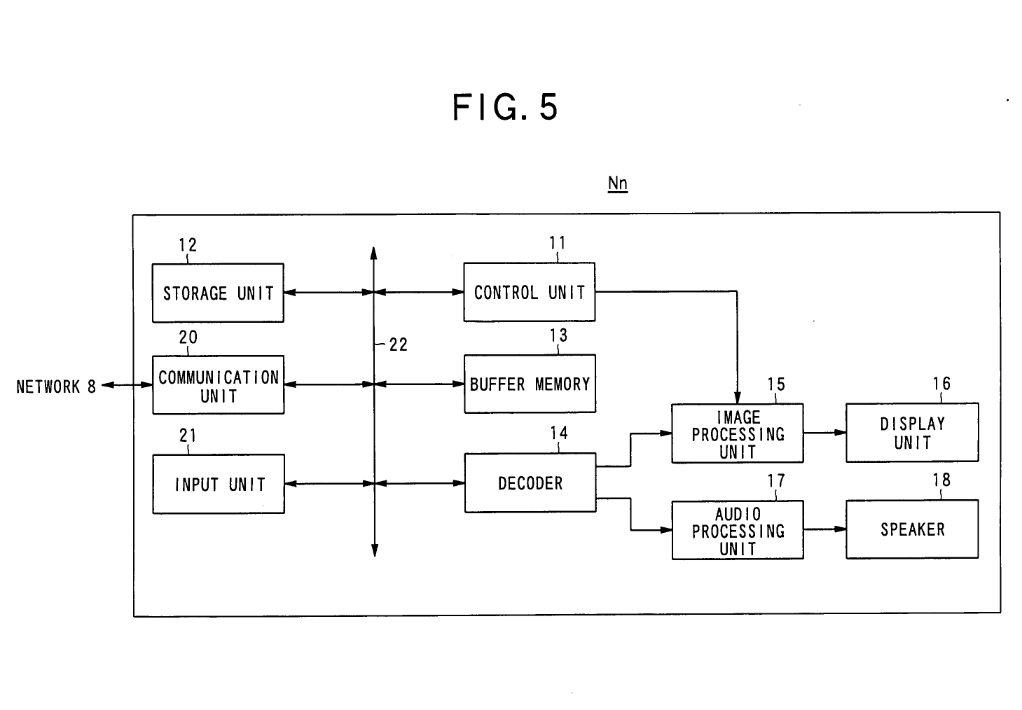

Next, with reference to FIG. 5, configuration and function of a node Nn will be explained.

FIG. 5 is a view showing a schematic configuration example of a node Nn.

Each of the node Nn is configured by including, as shown in FIG. 5: a control unit 11 being a computer configured by a CPU having computing function, a RAM for work, and a ROM for storing various data and programs; a storage unit 12 configured by an HD or the like for storing and retaining (storing) various data (e.g. a replica of content data, index information, DHT and the like), various types of programs and the like; a buffer memory 13 for temporarily storing a replica of received content data or the like; a decoder 14 for decoding (stretching data or decrypt) encoded video data (image information) and audio data (voice information) included in a replica of the content data; an image processing unit 15 for providing a predetermined graphic process to the video data thus decoded or the like and outputting the data as video signal; a display unit 16 such as CRT or liquid crystal display for displaying image based on the video signal outputted from the image processing unit 15, or the like; an audio processing unit 17 for converting the decoded audio data in use of digital/analog (D/A) conversion into an analog audio signal, amplifying the converted signal by an amplifier and outputting the same; a speaker 18 for outputting the audio signal outputted from the audio processing unit 17 as acoustic wave; a communication unit 20 for carrying out communication control of information with respect to other node devices and servers via the network 8; and an input unit 21 (for example, such as a key board, a mouse, or an operation panel) for receiving instruction signal from a user and providing the instruction signal corresponding to the instruction to the control unit 11, wherein the control unit 11, the storage unit 12, the buffer memory 13, the decoder 14, the communication unit 20, and the input unit 21 are connected each other via a bus 22. Here, a personal computer, a set top box (STB), or a TV receiver are applicable as the nodes Nn. Moreover, in the storage unit 12, IP address, a port number, and the like of a contact node to be an access target when participating in the distributed content storing system S are stored.

In such the configuration, when CPU in the control unit 11 reads out and carries out a program stored in the storage unit 12 or the like, the control unit 11 controls its entirety, carries out a process as any one of the above-mentioned user node, a relay node, a root node, a cache node, and a content retention node by participating in the distributed content storing system S, and functions as a storing request receiving means, a standard judgment means, a content data acquisition means, a load information acquisition means, a node number information acquisition means, a measuring means, a consumption band information acquisition means, a storing request information transfer means and the like according to the present invention as the user node. Moreover, the control unit 11 functions as a provision request receiving means, a standard judgment means, a content data providing means, a load information acquisition means, a node number information acquisition means, a measuring means, a consumption band information acquisition means and the like according to the present invention as a content retention node.

Specifically, in a case where the control unit 11 of a user node receives a storing request (storing request information) of content data (e.g. in a case where a content search instruction of content data selected through the input unit 21 by a user on the basis of content catalog information is received or in a case where a content input request (storing request) message from a content management server is received), in response to the storing request information, whether or not a standard for determining a degree of load of the network 8 is satisfied is judged to judge whether or not there is usage restriction of the system S.

Here, as a standard for determining a degree of load of the network 8 or the like, for example, usage restriction time of the distributed content storing system S (e.g. between 21:00 and 03:00 which many users use the distributed content storing system S), volume of load of a router to which the own node Nn is connected (an example of a relay device connected to each of a plurality of nodes Nn including the own node Nn and the network 8 for relaying data. Other than this, a bridge, a repeater, a switch or the like is conceivable.), a total number of nodes Nn connected to a router to which the own node Nn is connected, reply time from another node Nn (or a server), consumption band of a line in the network 8 to which the own node Nn is connected, and the like are included.

Then, the control unit 11 transmits a content location inquiry (search) message (query) including a content ID of content data regarding the storing request information and IP address and the like of the own node to a root node, as mentioned above, when the above-mentioned standard is satisfied (e.g. any one or two or more of the following are satisfied: a case where the present time is not in the usage restriction time of the distributed content storing system S; a volume of load of the router does not exceed a previously set standard; a total number of a node Nn connected to the above-mentioned router does not exceed a previously set standard number; a reply time from another node Nn does not exceed previously set standard time; and a consumption band of a line to which the own node Nn is connected does not exceed a previously set standard value) (it is judged that there is restriction of usage of the system S) and a replica of the content data is acquired and stored from another node Nn being a content retention node storing the replica (in other words, when the above-mentioned standard is not satisfied, a replica of the content data is not acquired). Thus, it is possible to reduce load of the network 8 and the router.

Moreover, in a case where the control unit 11 of a content retention node receives provision request information indicative of a provision request of content data from another node Nn being a user node (e.g. in a case where the above-mentioned content transmission request message is received), it is judged whether or not a standard for determining a degree of load of the network 8 is satisfied in response to the provision request information (similarly to the case of the user node). In a case where it is judged that the standard is satisfied (it is judged that there is usage restriction of the system S), as mentioned above, a replica of content data regarding the provision request information is transmitted to the user node through the network 8 (in other words, in a case where the standard is not satisfied, the replica of the content data is not transmitted).

For example, the above-mentioned node process program may be downloaded from a predetermined server of the network 8 or may be recorded in a recording medium such as a CD-ROM and read out through a drive unit of the recording medium.

### [3. Operation of Distributed Content Storing System S]

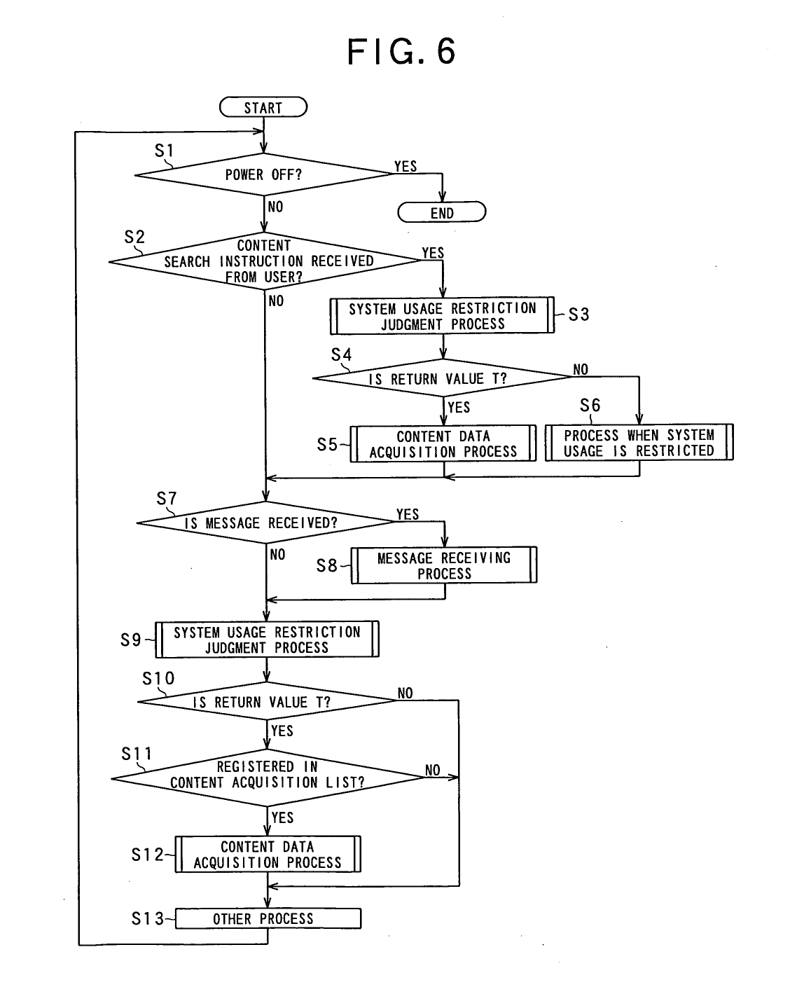

Next, operation of the distributed content storing system S will be explained with reference to FIGS. 6 to 10 and the like.

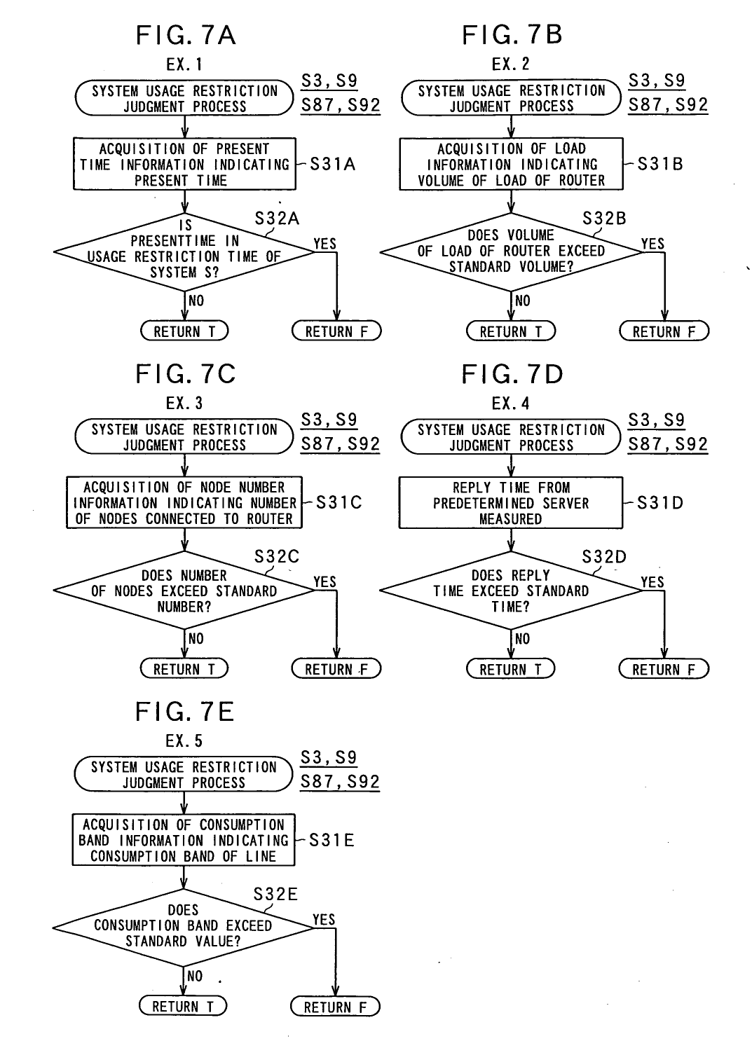

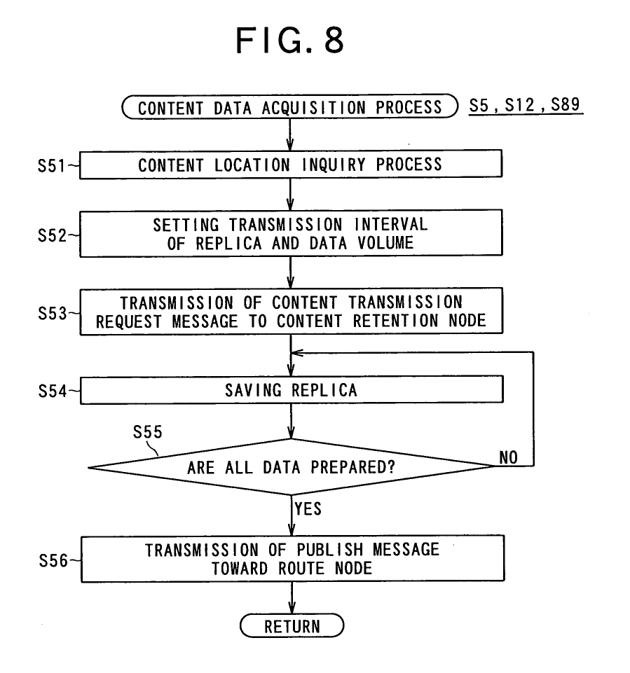

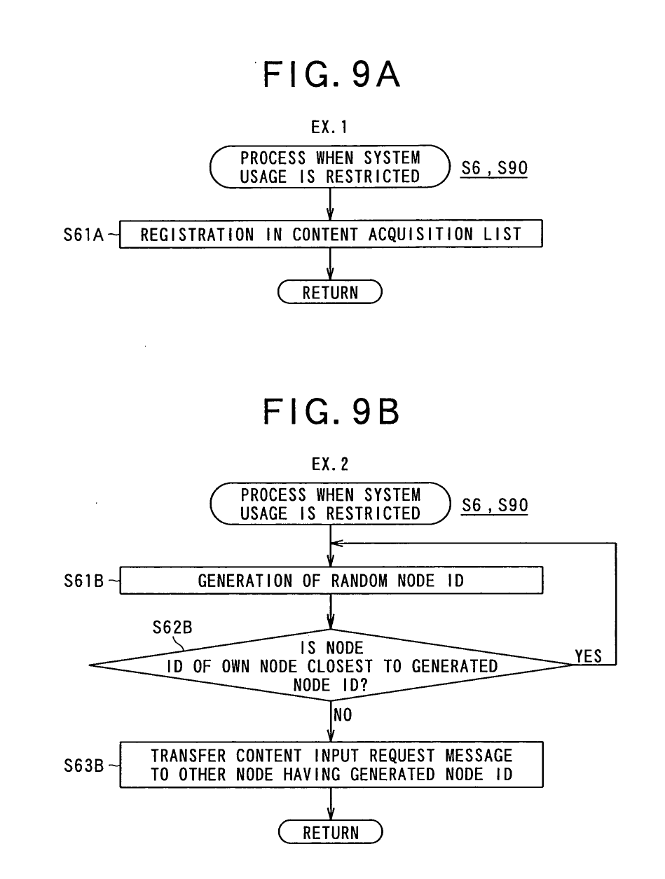

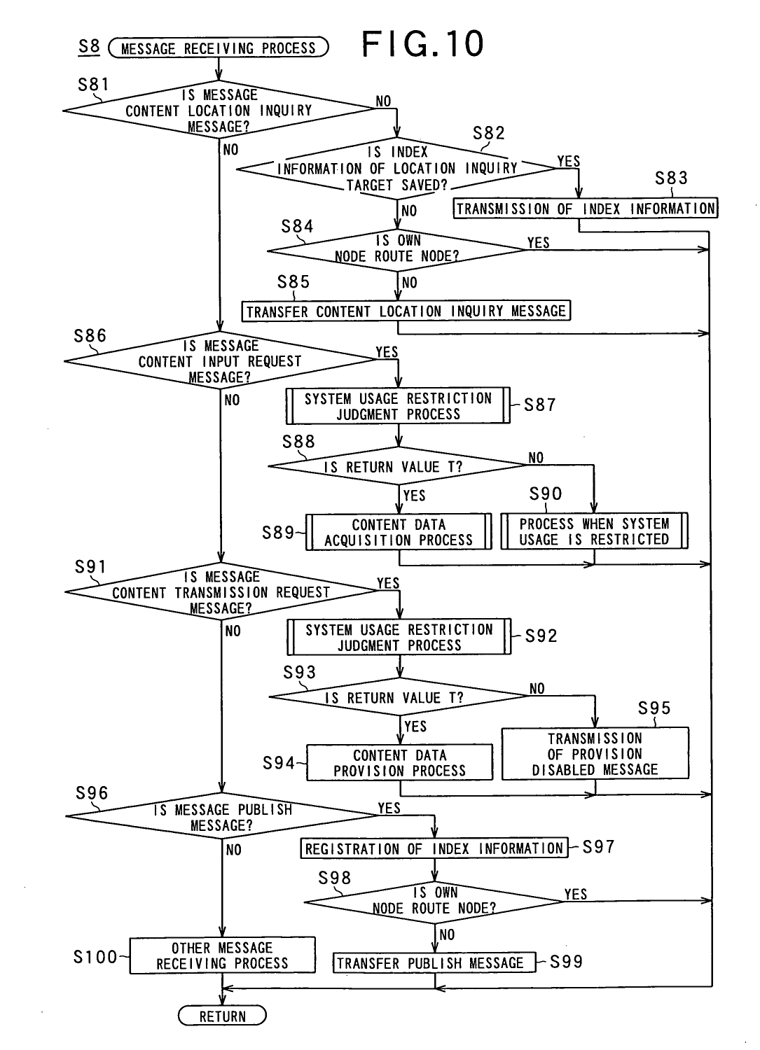

FIG. 6 is a flowchart showing a main process in a control unit 11 of the node Nn. FIGS. 7(A) to (E) are flowcharts showing details of a system usage restriction judgment process in FIGS. 6 and 10. FIG. 8 is a flowchart showing details of content data acquisition process in FIGS. 6 and 10. FIGS. 9(A) and (B) are flowcharts showing details when system usage is restricted in FIGS. 6 and 10. FIG. 10 is a flowchart showing details of message receiving process in FIG. 6.

Process shown in FIG. 6 is started for example in a case where power is supplied to an arbitrary node Nn whereby participation process into the distributed content storing system S is executed. In this participation process, the control unit 11 of the node Nn acquires an IP address and a port number of a contact node from the storage unit 12, is connected to the contact node through the network 8 on the basis of the acquired IP address and the port number, and transmits a participation message indicative of participation request (including a node ID, node information, and the like of the own node). Thus, a routing table is transmitted to the node Nn from another node Nn participating in the system S. On the basis of the routing table thus received, the own node Nn generates a routing table of its own and participation into the distributed content storing system S is finished. Here, because a generation method of the routing table is not directly related to the present invention and therefore detailed explanation thereof is omitted. Moreover, information such as the IP address or the like of a contact node is stored in the storage unit 12, for example, when a node Nn is shipped or initial condition of a node when a software is installed for the first time.

When participation process into the distributed content storing system S is thus completed, the control unit 11 finishes the process in a case where an instruction to turn off the power (e.g. a power off operation instruction through the input unit 21 from a user) (Step S1: YES) is received. On the other hand, in a case where the instruction to turn off the power is not received (Step S1: NO), the control unit 11 judges whether or not a content search instruction is received from the user through the input unit 21 (Step S2). In a case where the content search instruction is received from the user (e.g. in a case where the user selects a content name or the like of desired content data by the input unit 21 from content catalog information shown on the display unit 12 to give a content search instruction) (Step S2: YES), the process proceeds to Step S3. In a case where the content search instruction is not received (Step S2: NO), the process proceeds to Step S7.

In Step S3, a system usage restriction judgment process is performed as a user node. Examples thereof include process shown in FIGS. 7(A) to (E). It is arbitrarily determined which process is to be adopted by each node Nn or by a system operator uniformly in the distributed content storing system S.

For example, in the system usage restriction judgment process shown in FIG. 7(A) (Ex. 1), the control unit 11 acquires present time information indicating the present time (Step S31A) and judges whether or not the present time is in a usage restriction time (e.g. time between 21:00 and 03:00) previously set (stored in a setting area of the storage unit 12) in the distributed content storing system S (Step S32A). In a case where the present time is in the usage restriction time (Step S32A: YES), because a degree of load of the network 8 or the like becomes high, a return value is set up to be “F” (system usage is restricted) and the process returns to a process shown in FIG. 6. In a case where the present time is not in the usage restriction time (Step S32A: NO), a return value is set up to be “T” (system usage is not restricted), and the process returns to process shown in FIG. 6.

Moreover, in the system usage restriction judgment process shown in FIG. 7(B) (Ex. 2), the control unit 11 acquires load information indicating volume of load of a router to which the own node Nn is connected (e.g. an average value per a unit time (e.g. one minute) of CPU utilization in the router) from the router (a router transmitting a log) (Step S31B) and judges whether or not the volume of load exceeds a previously set (stored in a setting area of the storage unit 12) standard volume (e.g. 70%) (Step S32B). In a case where the volume of load exceeds the standard volume (Step S32B: YES) because a degree of load of the network 8 or the like becomes high, a return value is set to be “F”, and the process returns to process shown in FIG. 6. In a case where the volume of load does not exceed the standard volume (Step S32B: NO), a return value is set to be “T” and the process returns to process shown in FIG. 6.

Further, in the system usage restriction judgment process of FIG. 7(C) (Ex. 3), the control unit 11 acquires a node number information indicating a number of all the terminals connected to a router to which the own node Nn is connected (all the terminals connected to the router irrespective of participation in the distributed content storing system S and possibility for participation therein) including a node Nn connected to the router (the number of the nodes Nn may be calculated on the basis of response from each node Nn after broadcasting to all the nodes Nn on the same segment) (Step S31C) and judges whether or not the number of the nodes Nn (total number) exceeds a previously set (stored in a setting area of the storage unit 12) standard number (Step S32C). In a case where the total number of the node Nn exceeds the standard number (Step S32C: YES) because a degree of load of the network 8 or the like becomes high, a return value is set to be “F” and the process returns to process shown in FIG. 6. In a case where the total number of the node Nn does not exceed the standard number (Step S32C: NO), a return value is set up to be “T” and the process returns to process shown in FIG. 6.

Further, in the system usage restriction judgment process shown in FIG. 7(D) (Ex. 4), the control unit 11 measures response time from a previously set server (e.g. the control unit 11 transmits “ping” and measures time when response is received) (Step S31D) and judges whether or not the measured response time exceeds previously set (stored in a setting area of the storage unit 12) standard time (Step S32D). In a case where the response time exceeds the standard time (Step S32D: YES), because a degree of load of the network 8 or the like becomes high, a return value is set up to be “F”, and the process returns to process shown in FIG. 6. In a case where the response time does not exceed the standard time (Step S32D: NO), a return value is set up to be “T”, and the process returns to process shown in FIG. 6.

Further, in the system usage restriction judgment process of FIG. 7(E) (Ex. 5), the control unit 11 acquires consumption band information indicative of consumption band (bps) of a line to which the own node Nn (e.g. node N2) is connected in the network 8 (e.g. a line 71 shown in FIG. 1) (for example, the control unit 11 requests a previously set other node Nn to transmit a predetermined amount of data and measures on the basis of data transmission volume or the like per a unit time) (Step S31E) and judges whether or not the consumption band exceeds a previously set (stored in a setting area of the storage unit 12) standard value (e.g. 60% of maximum consumption band) (Step S32E). In a case where the consumption band exceeds the standard value (Step S32E: YES), because a degree of load of the network 8 or the like becomes high, a return value is set up to be “F”, and the process returns to the process shown in FIG. 6. In a case where the consumption band does not exceed the standard value (Step S32E: NO), a return value is set up to be “T” and the process returns to process shown in FIG. 6.

Here, a combination of any of process in FIGS. 7(A) to (E) may be adopted. For example, it may construct even when the present time is in the usage restriction time of the distributed content storing system S, in a case where the volume of load of the router does not exceed the previously set standard volume (or in a case where the total number of node Nn connected to the router does not exceed the previously set standard number), such that a return value is set up to be “T” and then the process returns to the process shown in FIG. 6.

Next, the control unit 11 judges whether or not the return value of the system usage restriction judgment process is “T” in Step S4 shown in FIG. 6. In a case where the return value is “T” (Step S4: YES), the process proceeds to Step S5. In a case where the return value is not “T” (return value is “F”) (Step S4: NO), the process proceeds to Step S6.

In Step S5, the control unit 11 executes content data acquisition process and the process proceeds to Step S7.

In the content data acquisition process, the control unit 11 carries out content location inquiry (search) process as shown in FIG. 8 (Step S51). In such content location inquiry (search) process, the control unit 11 transmits a content location inquiry (search) message including a content ID of content data with regard to the content search instruction in the above-mentioned Step S2 to another node Nn according to a routing table using own DHT (that is, a node Nn having a node ID closest to the content ID (e.g. upper digits match the most)) (transmits to a root node of the content ID) and acquires index information from a root node of the content ID.

Next, the control unit 11 sets a transmission (download) interval of a replica and a volume of data in one download (Step S52) and transmits a content transmission request message including information specifying the transmission interval and data volume thus set to a content retention node on the basis of an IP address or the like included in the index information thus acquired (Step S53). In response thereto, the content retention node transmits a replica of content data specified by the content transmission request message to the user node. At this time, the content retention node divides the replica by the data volume (block) thus specified and transmits with a transmission interval thus specified by the content transmission request message.

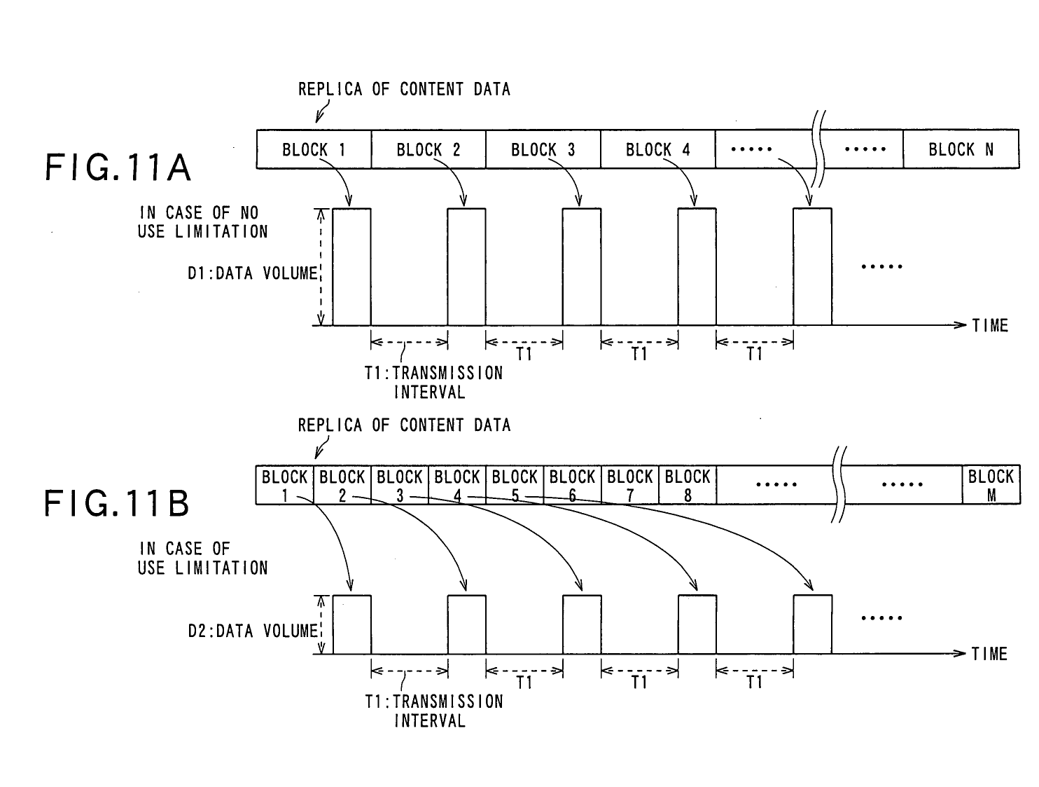

FIG. 11(A) shows how each block of a replica is transmitted from a content retention node with a transmission interval T1 in the system usage non-restriction time. Here, each block included in the replica of the content data may be configured to be stored by different content retention nodes, and a user node may transmit a content transmission request message including information specifying data volume thus set to each content retention node with the transmission interval thus set.

Then, each block transmitted from a content retention node is received through the communication unit 20 and is accumulated in the buffer memory 13. The control unit 11 causes data of the block to be stored and stored in the storage unit 12 from the buffer memory 13 when a predetermined amount of data of the block are accumulated in the buffer memory 13 (e.g. writes the data in a predetermined area of an HD) (Step S54). Thus, data of the block are sequentially stored and stored in the storage unit 12 from the buffer memory 13.

Next, the control unit 11 judges whether or not all the blocks included in a replica are accumulated, saved, and stored (Step S55). In a case where all the blocks are not saved and stored (Step S55: NO), the process returns to Step S54 to continue the process. In a case where all the blocks are saved and stored (Step S55: YES), the process proceeds to Step S56. Here, in a case where data volume of the replica is small, the data may be saved and stored in the storage unit 12 after all the blocks are accumulated in the buffer memory 13.

Next, the control unit 11 transmits the above-mentioned publish message including a content ID of content data regarding the replica thus saved to another node Nn according to a routing table using own DHT (transmits to a root node of the content ID) (Step S56). Then the process returns to one in FIG. 6. By this, the publish message reaches a root node by a DHT routing using a content ID as a key, and the root node registers index information including a pair of an IP address or the like included in the publish message thus received and the content ID.

In Step S6, a process in system usage restriction time is carried out as a user node. Examples thereof include process shown in FIGS. 9(A) and (B). Which process is to be adopted is arbitrarily determined by each node Nn or by a system operator uniformly in the distributed content storing system S.

For example, in the process at a system usage restriction time shown in FIG. 9(A) (Ex. 1), the control unit 11 registers a content ID or the like of content data regarding the content search instruction in the above-mentioned Step S2 in a content acquisition list for registering, for example, a content ID or the like of content data to be acquired when system usage restriction is released (wait until the standard is satisfied) (Step S61A). Then the process returns to process in FIG. 6.

Moreover, in the process at a system usage restriction time shown in FIG. 9(B) (Ex. 2), the control unit 11 generates a random node ID (Step S61B) and judges whether or not a node ID of the own node Nn is closest to the node ID thus generated (e.g. upper digits match the most) among all the node IDs registered in a routing table using own DHT (Step S62B). In a case where the node ID of the own node Nn is closest to the node ID thus generated (Step S62B: YES), the process returns to Step S61B and the same process is carried out. Meanwhile, in a case where the node ID of the own node Nn is not closest to the node ID thus generated (Step S62B: NO), the control unit 11 specifies another node Nn having a node ID closest to the node ID thus generated and transfers a content input request message to the node Nn (Step S63B).

Here, the control unit 11 may specify another node Nn randomly from the routing table using own DHT and transmit a content input request message to the another node Nn without generating a random node ID.

Moreover, as another example during the system usage restriction time, the control unit 11 may lower acquisition (download) speed of content data per a unit time and acquire and save a replica of the content data from the content retention node. In this case, in the above-mentioned Step S6, content data acquisition process shown in FIG. 8 is carried out as process during the system usage restriction time, and the control unit 11 sets up to reduce the volume of data of a replica in one download (FIG. 11(B)) to be smaller than during system usage non-restriction time in Step S52 (same transmission (download) interval of replica is applied). Thus, acquisition (download) speed of content data as entire replica is lowered and load of the network 8 and a router can be suppressed. Here, in Step S52, transmission (download) interval of a replica may be set longer than (set longer than the transmission interval T1 shown in FIG. 11) the one in the system usage non-restriction time.

After the above-mentioned process when system usage is restricted is carried out, the process proceeds to Step S7.

Next, in Step S7, the control unit 11 judges whether or not a message transmitted from another node Nn is received. In a case where the message is not received (Step S7: NO), the process proceeds to Step S9. In a case where the message is received (Step S7: YES), the process proceeds to Step S8 to carry out message receiving process.

In the message receiving process, as shown in FIG. 10, the control unit 11 judges whether or not the message thus received is a content location inquiry message (Step S81). In a case where the message is not a content location inquiry message (Step S81: NO), the process goes to Step S86. In a case where the message is a content location inquiry message (Step S81: YES), the control unit 11 judges whether or not index information of location inquiry target (index information corresponding to a content ID included in the content location inquiry message) is saved in index cache (Step S82). In a case where the index information is saved (Step S82: YES), the index information is transmitted to a user node being the transmitter of the content location inquiry message (Step S83), and the process returns to process shown in FIG. 6. On the other hand, in a case where the index information is not saved (Step S82: NO), the control unit 11 judges whether or not the own node Nn is a root node (i.e. refers to own routing table and judges whether or not a node ID closest to the content ID included in the content location inquiry message is the node ID of the own node) (Step S84). In a case where the own node is not a root node (i.e. own node is a relay node) (Step S84: NO), the process goes to Step S85. In a case where the own node is a root node (Step S84: YES), the process returns to the process shown in FIG. 6.

In Step S85, the control unit 11 transfers the content location inquiry message thus received to another node Nn (i.e. a node Nn having a node ID closest to the content ID included in the content location inquiry message) according to a routing table using own DHT (transmits to a root node of the content ID) and the process returns to the process shown in FIG. 6.

In Step S86, the control unit 11 judges whether or not the message thus received is a content input request message. In a case where the message is not a content input request message (Step S86: NO), the process proceeds to Step S91. On the other hand, in a case where the message is a content input request message (Step S86: YES), similarly to the above-mentioned Step S3, the system usage restriction judgment process (one of any of process shown in FIGS. 7(A) to (E) or a combination of any of them) is carried out as a user node (Step S87).

Subsequently, the control unit 11 judges whether or not a return value of the system usage restriction judgment process is “T” (Step S88). In a case where the return value is “T” (Step S88: YES), similarly to the above-mentioned Step S5, content acquisition process is carried out (Step S89). In a case where the return value is not “T” (return value is “F”) (Step S88: NO), similarly to the above-mentioned Step S6, process when system usage is restricted is carried out (Step S90) and the process returns to the process shown in FIG. 6.

In Step S91, the control unit 11 judges whether or not the message thus received is a content transmission request message. In a case where the message is not a content transmission request message (Step S91: NO), the process goes to Step S96. On the other hand, in a case where the message is a content transmission request message (Step S91: YES), the system usage restriction judgment process (one of any of process shown in FIGS. 7(A) to (E) or a combination of any of them) is carried out as a content retention node (Step S92).

Here, in a case where the system usage restriction judgment process is carried out as a content retention node, a standard (a standard volume, a standard number, a standard time, a standard value) may be set more moderate than in a case where the system usage restriction judgment process is carried out as a user node. For example, in a case where process of FIG. 7(E) is carried out as a user node, a standard value is set up to be for example 60% of the maximum consumption band, in a case where process of FIG. 7(E) is carried out as a content retention node, a standard value is set up to be for example 80% of the maximum consumption band. This is because while a node functions as a content retention node (uploading), download by a user node is carried out smoothly by setting the restriction moderate.

Next, the control unit 11 judges whether or not a return value of the system usage restriction judgment process is “T” (Step S93). In a case where the return value is “T” (Step S93: YES), content data provision (upload) process is carried out (Step S94), and the process returns to process shown in FIG. 6. In the content provision process, as mentioned above, a replica of content data specified by the content transmission request message thus received is sequentially transmitted to a user node being a transmitter of the content transmission request message for each block.

On the other hand, in a case where the return value is not “T” (Step S93: NO), the control unit 11 transmits a provision disabled message indicating that transmission (provision) of a replica of content data cannot be carried out to a user node being the transmitter of the content transmission request message through the communication unit 20 or the like (Step S95) and the process returns to process shown in FIG. 6.

In Step S96, the control unit 11 judges whether or not the message thus received is a publish message. In a case where the message is not a publish message (Step S96: NO), the process goes to Step S100. On the other hand, in a case where the message is a publish message (Step S96: YES), index information including a pair of an IP address or the like and a content ID included in the publish message thus received is registered (saved in index cache area) (Step S97).

Subsequently, the control unit 11 judges whether or not the own node is a root node, similarly to the above-mentioned Step S84 (Step S98). In a case where the own node is not a root node (i.e. own node is a relay node) (Step S98: NO), the process proceeds to Step S99. In a case where the own node is a root node (Step S98: YES), the process returns to process shown in FIG. 6.

In Step S99, the control unit 11 transfers the publish message thus received to another node Nn according to own routing table (i.e. a node having a node ID closest to the content ID included in the publish message) (transmits to a root node of the content ID). Then the process returns to process shown in FIG. 6.

Here, regarding other message receiving process in Step S100, process in a case where other message (e.g. a participation message) is received is carried out.

Next, in Step S9 shown in FIG. 6, system usage restriction judgment process is carried out similarly to the above-mentioned Step S3.

Then, the control unit 11 judges whether or not a return value of the system usage restriction judgment process is “T” (Step S10). In a case where the return value is “T” (that is, when a standard is satisfied and system usage is not restricted) (Step S10: YES), the process goes to Step S11. In a case where the return value is not “T” (Step S10: NO), the process goes to Step S13.

In Step S1, the control unit 11 judges whether or not a content name and a content ID of content data is registered in a content registration list (registered in above-mentioned Step S6 or Step S90). In a case where the content name and the content ID are not registered (Step S11: NO), the process goes to Step S13. In a case where the content name and content ID are registered (Step S11: YES), the content data acquisition process is carried out in a manner similar to the above-mentioned Step S5 (Step S12). That is, in a case where a standard is not satisfied (return value is “F”) as a result of the system usage restriction judgment process (Step S3 or Step S87), the control unit 11 registers in the content acquisition list and waits until the standard is satisfied. Then, when the standard is satisfied as a result of the system usage restriction judgment process in Step S9, the control unit 11 acquires (download) a replica of the content data from a content retention node and stores the replica.

Here, in other process in Step S13, for example, process corresponding to an instruction by a user through the input unit 21 or the like is carried out and the process returns to Step S1.

As explained above, according to the present embodiment, in a case where a user node receives a storage request of content data (storage request information), in order to judge whether or not usage of the system S is restricted in response to the storage request information, it is discriminated whether or not above-mentioned standard for determining a degree of load of the network 8 is satisfied. In a case where the standard is satisfied (e.g. any one or two or more of the following are satisfied: a case where a present time is not in a usage restriction time range of the distributed content storing system S; a volume of load of the above-mentioned router does not exceed a previously set standard volume; a total number of nodes Nn connected to the above-mentioned router does not exceed a previously set standard number; a reply time from another node Nn does not exceed a previously set standard time; and a consumption band of a line to which the own node Nn is connected does not exceed a previously set standard value), (it is judged that there is a limitation in using the system S). Then it is constructed such that a content location inquiry (search) message (query) including a content ID of content data regarding the storing request information, an IP address of the own node or the like is transmitted to a root node, and a replica of content data is acquired from another node Nn being a content retention node which stores the replica through the network 8 and saved. Therefore, even in a case where many nodes Nn are connected to one line configuring the network 8 through a relay device such as a router (one line is shared), it is possible to reduce load of the network and the relay device such as a router. Moreover, it is possible to avoid a user of another node Nn from being disturbed when the network is busy.

Further, in a case where a content retention node received provision request information indicating provision request of content data from another node Nn, being a user node, it is judged whether or not a standard for determining a volume of load of the network 8 is satisfied in response to the provision request information. In a case where the above-mentioned standard is satisfied (it is judged that usage of the system S is restricted), a replica of content data regarding the provision request information is transmitted to the user node through the network 8. Therefore, even in a case where many nodes Nn are connected to one line configuring the network 8 through a relay device such as a router (one line is shared), it is possible to reduce load of the network and the relay device such as a router.

Further, each node Nn can be configured to avoid throwing-in of a replica of the content data as much as possible when a content throwing-in request (storage request) message is received from a content management server, and a standard for determining a degree of load in the network 8 is not satisfied.

Here, the explanation was given on a premise that the distributed content storing system S of the above-mentioned embodiment is configured by algorithm using DHT. However, the present invention is not limited thereto.

The present invention is not confined to the configuration listed in the foregoing embodiments, but it is easily understood that the person skilled in the art can modify such configurations into various other modes, within the scope of the present invention described in the claims.

What is claimed is:

1. A node device included in a distributed content storing system which includes a plurality of node devices enabled to mutually communicated through a network, the plurality of node devices including a plurality of content data distributed and stored therein, the node device comprising:
a storing request receiving means for receiving storing request information indicative of storing request of the content data;
a standard judgment means for judging whether or not a standard for determining a degree of load of the network in response to the storing request information; and
a content data acquisition means for acquiring and storing content data related to the storing request information from another node device storing the content data through the network in a case where the standard is satisfied.

2. The node device according to claim 1,
wherein the standard judgment means judges whether or not the present time is in a usage restriction time band, previously set in the distributed content storing system; and
the content data acquisition means acquires and saves content data from another node device storing the content data related to the storing request information in a case where the present time is not in the usage restriction time.

3. The node device according to claim 1, further comprising:
a load information acquisition means for acquiring load information indicative of a volume of load of a relay device, which is connected to a plurality of node devices including the own node device and the network and relays data,
wherein the standard judgment means judges whether or not the volume of load indicated by the load information thus acquired exceeds a previously set standard volume; and
the content data acquisition means acquires and saves content data from another node device storing the content data related to the storing request information in a case where the volume of load does not exceed the standard volume.

4. The node device according to claim 1, further comprising:
a node number information acquisition means for acquiring node number information indicative of a number of the node devices, connected to the relay device, which are connected to the plurality of node devices including the own node device and the network and relays the data,
wherein the standard judgment means judges whether or not a number of node devices indicated by the node number information thus acquired exceeds a previously set standard number, and
the content data acquisition means acquires and stores content data from another node device storing the content data related to the storing request information in a case where the number of node devices does not exceed the standard number.

5. The node device according to claim 1, further comprising:
a measuring means for measuring a reply time from another device through the network,
wherein the standard judgment means judges whether or not the reply time thus measured exceeds a previously set standard time, and
the content data acquisition means acquires and stores content data from another node device storing the content data related to the storing request information in a case where the reply time does not exceed the standard time.

6. The node device according to claim 1, further comprising:
a consumption band information acquisition means for acquiring consumption band information indicative of a consumption band of the network,
wherein the standard judgment means judges whether or not consumption band thus acquired exceeds a previously set standard value, and
the content data acquisition means acquires and stores content data from another node device storing the content data related to the storing request information in a case where the consumption band does not exceed the standard value.

7. The node device according to claim 1,
wherein the content data acquisition means waits until the standard is satisfied in a case where the standard is not satisfied, and when the standard is satisfied, the content data acquisition means acquires and stores content data from another node device storing the content data related to the storing request information.

8. The node device according to claim 1,
wherein the content data acquisition means lowers acquisition speed of the content data, and acquires and stores the content data from another node device storing the content data related to the storing request information in a case where the standard is not satisfied.

9. The node device described in claim 1, further comprising:
a storing request information transfer means for transferring the storing request information to another node device in a case where the standard is not satisfied.

10. A node device included in a distributed content storing system including a plurality of node devices enabled to mutually communicate wherein a plurality of content data are distributed and stored in a plurality of node devices comprising:
a provision request receiving means for receiving provision request information indicative of a provision request of the content data from another node device;
a standard judgment means for judging whether or not a standard for determining a degree of load of the network is satisfied in response to the provision request information; and
a content data providing means for transmitting content data related to the provision request information to the another node deice through the network when the standard is satisfied.

11. The node device according to claim 10,
wherein the standard judgment means judges whether or not the present time is in a usage restriction time band previously set up in the distributed content storing system, and
the content data providing means transmits content data related to the provision request information to the another node device in a case where the present time is not in the usage restriction time.

12. The node device according to claim 10, further comprising:
a load information acquisition means for acquiring load information indicative of a volume of load of a relay device, which is connected to the plurality of node devices including the own node device and the network and relays data,
wherein the standard judgment means judges whether or not a volume of load indicated by the load information thus acquired exceeds a previously set standard volume, and
the content data acquisition means transmits content data related to the provision request information to the another node device in a case where the volume of load does not exceed the standard volume.

13. The node device according to claim 10, further comprising:
a node number information acquisition means for acquiring node number information indicative of a number of the node devices, connected to the relay device, which are connected to a plurality of node devices including the own node device and the network and relays data,
wherein the standard judgment means judges whether or not a number of the node devices indicated by the node number information thus acquired exceeds a previously set standard number, and
the content data providing means transmits content data related to the provision request information to the another node device in a case where the number of node devices does not exceed the standard number.

14. The node device according to claim 10, further comprising:
a measuring means for measuring a reply time from another device through the network;
wherein the standard judgment means judges whether or not the reply time thus measured exceeds the previously set standard time; and
the content data providing means transmits content data related to the provision request information to the another node device in a case where the number of the node devices does not exceed the standard time.

15. The node device according to claim 10, further comprising:
a consumption band information acquisition means for acquiring consumption band information indicative of a consumption band of the network,
wherein the standard judgment means judges whether or not the consumption band thus acquired exceeds previously set standard value, and
the content data providing means transmits content data related to the provision request information to the another node device in a case where the number of node devices does not exceed the standard value.

16. A node process program causing a computer to function as a node device according to claim 1.

17. A distributed content storing system including a plurality of node devices enabled to mutually communicate through a network, the plurality of node devices including a plurality of content data distributed and stored therein, the node device comprising:
a storing request receiving means for receiving storing request information indicative of a storage request of the content data;
a standard judgment means for judging whether or not a standard for determining a degree of load of the network in response to the storing request information; and
a content data acquisition means for acquiring and storing content data related to a storing request information from another node-device, storing the content data from another node device through the network in a case where the standard is satisfied.

18. A content data acquisition method in a distributed content storing system including a plurality of node devices enabled to mutually communicate through a network, the plurality of node devices including a plurality of content data distributed and stored therein, the node device carries out:
a step of receiving storing request information indicative of storing request of the content data;
a step of judging whether or not a standard for determining a degree of load of the network is satisfied in response to the storing request information; and
a step of acquiring and storing content data related to the storing request information from another node device storing the content data through the network in a case where the standard is satisfied.

19. A distributed content storing system including a plurality of node devices enabled to mutually communicate through a network, the plurality of node devices including a plurality of content data distributed and stored therein, the node device comprising:
a provision request receiving means for receiving provision request information indicative of provision request of the content data from another node device;
a standard judgment means for judging whether or not a standard for determining a degree of load of the network is satisfied in response to the provision request information; and
a content data providing means for transmitting content data related to the provision request information to the another node device through the network in a case where the standard is satisfied.

20. A content data providing method in a distributed content storing system including a plurality of node devices enabled to mutually communicate through a network, the plurality of node devices including a plurality of content data distributed and stored therein, the node device carrying out:
a step of receiving provision request information indicative of provision request of the content data from another node device;
a step of judging whether or not a standard for determining a degree of load of the network is satisfied in response to the provision request information; and
a step of transmitting the content data related to the provision request information to the another node device through the network in a case where the standard is satisfied.
